(19) United States
(12) Patent Application Publication
(10) Pub. No.: US 2007/0108740 A1
(43) Pub. Date: May 17, 2007

(54) APPARATUS AND METHOD FOR UNIVERSAL ATTACHMENT OF INFLATABLE CUSHION

(76) Inventors: John D. Salmon III, Dayton, OH (US); John C. Weber, Springboro, OH (US); Harold W. Morgan, Miamisburg, OH (US)

Correspondence Address: CANTOR COLBURN, LLP, 55 GRIFFIN ROAD SOUTH, BLOOMFIELD, CT, 06002, US

(21) Appl. No.: 11/560,354

(22) Filed: Nov. 15, 2006

Related U.S. Application Data
(60) Provisional application No. 60/737,081, filed on Nov. 16, 2005.

(51) Int. Cl. B60R 21/217

(52) U.S. Cl. 280/728.2; 280/728.3

(57) ABSTRACT

Exemplary embodiments of the present invention are related to an apparatus and method for a universal attachment device for an inflatable cushion. The apparatus comprising an integrally molded attachment device for an inflatable cushion, the device comprising: a flexible portion; a cushion ring disposed on a first side of the flexible portion; and a cover retainer disposed on a second side of the flexible portion, wherein the cushion ring and the cover retainer are formed by an injection molding process wherein the flexible portion is disposed between the cushion ring and the cover retainer.

### CROSS REFERENCE TO RELATED PATENT APPLICATIONS

This application claims the benefit of U.S. Provisional Patent Application Ser. No. 60/737,081 filed Nov. 16, 2005, the contents of which are incorporated herein by reference thereto.

### TECHNICAL FIELD

The present invention relates to airbag modules and more particularly the present invention relates to an apparatus and method for providing a unitary mechanism for securing component parts of the airbag module together.

### BACKGROUND

Vehicles are supplied with driver side airbag modules, passenger side airbag modules and side airbag modules. Various mounting mechanisms have been used for securing airbag modules to support structures in a vehicle. Non-limiting examples of such support structures include steering wheels and vehicle instrument panels.

In one known mounting mechanism, mounting bolts are passed through openings in multiple components of the airbag module wherein a threaded portion of the mounting bolts engages a complimentary nut or threaded portion of the airbag module after the same has been passed through a series of openings in multiple components of the module. Accordingly, these attachment assemblies comprise numerous parts that require additional installation steps and costs.

Therefore, it is desirable to provide an apparatus and method for providing a securement feature for an airbag module assembly that uses a minimal amount of components and is easy to install and manufacture thereby reducing the associated costs.

### SUMMARY

Exemplary embodiments of the present invention are related to an apparatus and method for a universal attachment device for an inflatable cushion. The apparatus comprising an integrally molded attachment device for an inflatable cushion, the device comprising: a flexible portion; a cushion ring disposed on a first side of the flexible portion; and a cover retainer disposed on a second side of the flexible portion, wherein the cushion ring and the cover retainer are formed by an injection molding process and wherein the flexible portion is disposed between the cushion ring and the cover retainer.

In an alternative exemplary embodiment an airbag module is provided. The airbag module comprising: an inflator for providing an inflation force to an inflatable cushion; a flexible portion; a cushion ring disposed on a first side of the flexible portion; and a cover retainer disposed on a second side of the flexible portion, wherein the cushion ring and the cover retainer are formed by an injection molding process wherein the flexible portion is disposed between the cushion ring and the cover retainer.

In yet another alternative exemplary embodiment a method for making an integrally molded attachment device for an inflatable cushion is provided. The method comprising: inserting a flexible portion within a pair of dies, a first one of the pair of dies having a first cavity portion disposed in a facing spaced relationship with a first side of the flexible portion, and a second one of the pair of dies having a second cavity portion disposed in a facing spaced relationship with a second side of the flexible portion; and molding a liquid plastic into the first cavity portion and the second cavity portion, wherein a cushion ring is formed on the first side of the flexible portion, and a cover retainer is formed on the second side of the flexible portion, and a portion of the flexible portion is mechanically bonded between the cushion ring and the cover retainer.

### BRIEF DESCRIPTION OF THE DRAWINGS

FIG. 1 is an exploded perspective view of an airbag module;

FIG. 2 is an exploded perspective view of a portion of the airbag module of FIG. 1;

FIG. 3 is a bottom perspective view of an exemplary embodiment of the present invention;

FIGS. 4 and 4A are side perspective views of an exemplary embodiments of the present invention;

FIG. 5 is a top perspective view of an exemplary embodiment of the present invention;

FIG. 6 is a bottom perspective view of an attachment device constructed in accordance with an exemplary embodiment of the present invention;

FIG. 7 is a top perspective view of an attachment device constructed in accordance with an exemplary embodiment of the present invention;

FIG. 8 is a side view of an injection molding apparatus used for forming an attachment device in accordance with an exemplary embodiment of the present invention; and

FIG. 9 is a view of an alternative exemplary embodiment of the present invention.

### DETAILED DESCRIPTION OF EXEMPLARY EMBODIMENTS

Exemplary embodiments of the present invention provide several alternatives to current airbag module assemblies. One alternative is in the attaching/holding of a fabric airbag cushion to the cushion ring in an airbag module. In current airbag systems, the module typically utilizes a separate metal retaining ring that is riveted or bolted together with other components in the airbag module assembly so as to merely pinch/squeeze the airbag cushion between the components. Such retaining rings are not completely gas sealed to the airbag cushion and exhibit a weight and assembly cost to the entire module assembly.

Another alternative relates to driver side airbag modules and relates to the attaching/holding of the airbag module cover to the airbag module prior and during deployment. Attaching/holding of the airbag cover to the module is necessary during an airbag deployment event. Currently airbag modules typically utilize a separate metal retaining plate that is crimped, riveted or bolted together with other components in the airbag module assembly so as to merely pinch/squeeze the airbag cover between the mounting plate component. Such retaining plates also add a weight and assembly cost to the entire airbag module assembly.

Exemplary embodiments of the present invention provide a novel low cost method for attaching an airbag cushion and airbag cover in an airbag module assembly. In accordance with an exemplary embodiment of the present invention, an economical, practical and production-orientated inflatable vehicle passenger restraint system is provided.

In accordance with an exemplary embodiment a method for securely fastening the airbag cushion and airbag cover together in an airbag module assembly, is provided by incorporating the functionality of both existing parts in the airbag cushion retainer and cover plate into a single injected molded part that has been molded directly into/to a piece of fabric that will be used to attach the new part to an airbag cushion. This molded-in piece of fabric along with the functionality of the other two existing parts (now removed and replaced by an injection molded part) makes up an exemplary embodiment of the present invention.

In accordance with an exemplary embodiment, this in-molded piece of fabric and the functionality of the other two existing parts makes up an exemplary embodiment of the present invention. In one embodiment, the molded component is separate from the airbag cushion, yet is easily attachable (sewing, adhesives, etc.) to the airbag cushion to form an airbag cushion assembly. In another exemplary embodiment, the molded component is molded directly to the fabric of the airbag cushion. Accordingly, exemplary embodiments of the present invention will save manufacturing time in the assembly of the airbag module and reduce costs by eliminating components and changing the material of what the parts are made up from.

In one non-limiting exemplary embodiment, the new unique attachment method will comprise in-molding a piece of fabric that will provide a sewing area or mounting area to sew the component onto the airbag cushion. Accordingly, the fabric will be integral with an exemplary embodiment of the present invention and will eliminate the separate metal cushion ring and cover plate currently being used as well as their associated assembly steps.

In one exemplary embodiment, this new in-molded piece of fabric is made up of the same fabric used in the airbag cushion so that it will also be able to structurally withstand the same deployment stresses as the airbag cushion during a deployment.

In another exemplary embodiment, the in-molded piece of fabric's sewing area will extend outwardly from the molded area of the assembly, wherein the sewing area is used to secure the new component to the airbag cushion during the assembly process. According to one exemplary embodiment, the fabric is insert molded into the assembly and then the extending areas or mounting flange is secured to the airbag cushion material.

According to another exemplary embodiment, the sewing area is defined as an area beyond the plastic injection molded area used for receiving sewing stitches when it is sewn to the airbag cushion.

According to a further embodiment, this sewing area is secured in the middle between the top and bottom halves of the molded component by a means of a mechanical bonding method during the injection molding process wherein the plastic is allowed to mix together through holes or openings in the fabric by receiving molten plastic from both sides of the injection molding process.

In accordance with an exemplary embodiment of the present invention a lightweight, inexpensive, yet strong, one-piece construction airbag cushion attachment method is provided, wherein an exemplary embodiment has incorporated into it a means to also attach and secure the airbag module cover.

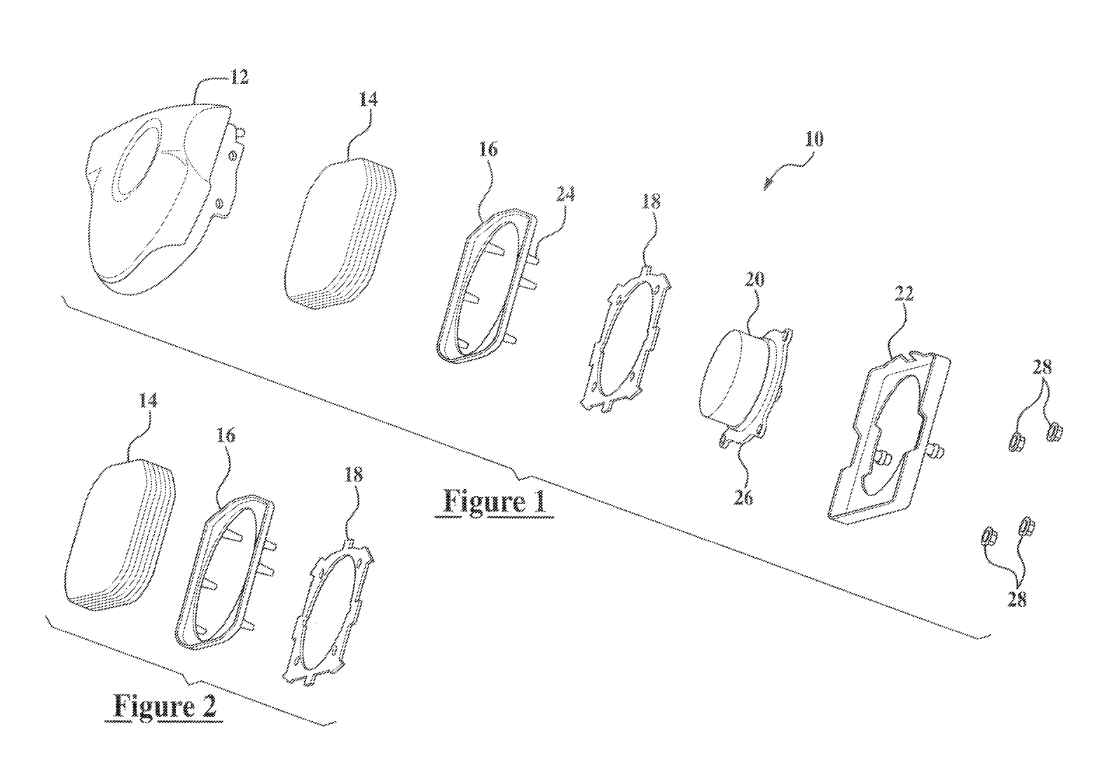

Referring now to FIGS. 1 and 2, a driver side airbag module 10 is illustrated. Driver side airbag module 10 is typically mounted to a hub or armature of a steering wheel (not shown). Typically, some form of mounting mechanism is provided to mount the airbag module components to each other and to the steering wheel. As will be disclosed herein, exemplary embodiments of the present invention are directed to mounting mechanisms for mounting portions of the airbag module together wherein the weight, cost and complexity of the same is reduced.

Generally, driver side airbag modules include a cover 12, an inflatable cushion 14, a cushion ring 16, a cover retainer 18, an inflator 20; and a retaining plate or pad retainer plate 22. Typically, the cushion retainer ring is formed from metal and is secured to one side of an inflator opening of the inflatable cushion while the cover retainer, which is also formed from metal, is disposed on the other side of the inflator opening. Thus, a periphery of the inflator opening of the inflatable cushion is disposed between the retainer ring and the cover retainer and the two are drawn together by tightening of a plurality of nuts about a plurality of threaded bolts passing through openings in the retainer ring, the periphery of the inflation opening of the inflatable cushion and the cover retainer. In other configurations, the cushion retainer ring is secured to the cover retainer by a plurality of bolts 24 passing through openings in the cushion ring, cover retainer, a flange 26 of the inflator, and the pad retainer plate. Thereafter, a plurality of nuts 28 are disposed about the threaded bolts securing the assembly together.

The cushion retainer ring is typically used for mounting/attaching the inflatable cushion to the airbag module. In other words, the retainer ring secures the opening of the inflatable cushion about a portion of the inflator as well as the backing plate, which is fixedly secured to the vehicle. In most airbag modules the cushion ring is typically a separate metal component that is riveted or bolted together with other adjoining components in the airbag module assembly so as to merely pinch/squeeze the airbag cushion between the adjoining components. Additionally, the airbag cover plate or backing plate is also one of these adjoining components, which is used to secure the airbag module's cover in the final assembly.

Referring to the exploded view of FIG. 1, a driver side air bag module typically comprises a cover, an airbag or inflatable cushion, a cushion ring, a cover retainer plate, an inflator, a cover or pad retainer plate and nuts to secure the assembly together. Although a driver's side airbag is shown it is understood that exemplary embodiments of the present invention are contemplated for use with passenger side airbag modules, side impact airbag modules and other devices wherein the integrally molded mounting portion is capable of simplifying the assembly process.

For assembly of the module in FIG. 1, a sub-assembly of a plate and cushion assembly (FIG. 2) is made up with an airbag or inflatable cushion with the cushion ring that is inserted inside the airbag through an opening in the airbag with the studs on the cushion ring passing through corresponding attachment holes in the airbag the a cover retainer is attached by aligning the studs on the cushion ring with the holes in the cover retainer and passing them through corresponding attachment holes in the cover retainer.

Attachment is completed, by crimping over the locking tabs on the cushion ring to secure the cover retainer to the cushion ring. The attached airbag of the sub assembly is now folded up and is now called a plate and cushion assembly. Thereafter, the folded plate and cushion assembly is inserted into a driver airbag cover. Then, the inflator is inserted and the openings in the inflator flange are oriented and lined up with the studs on the cushion ring.

Then the pad retainer plate is oriented and lined up with the studs on the cushion ring. The last step in assembling the driver side airbag module is to apply and tighten the nuts on the cushion ring studs. Accordingly, exemplary embodiments of the present invention provide a cheaper and more efficient way to attach the airbag or inflatable cushion to the pad retainer plate in driver side airbag modules, passenger side airbag modules and other airbag modules by removing some of these components and their associated assembly steps. In accordance with an exemplary embodiment the current metal cushion ring and cover retainer are eliminated and their functionality are combined into a common part usable with all airbag modules. Moreover and in accordance with an exemplary embodiment, the functionally of the cushion ring and the cover retainer plate are combined into a single injected molded component with an additional item being added in the molding process. In accordance with an exemplary embodiment, this additional item is a piece re-enforced fabric that will become a universal adapter flange that extends outside the perimeter of the new injected molded part. In accordance with an exemplary embodiment, the re-enforced fabric or universal adapter flange is sewn or secured directly onto an airbag cushion or inflatable cushion proximate to an inflation opening.

In accordance with an exemplary embodiment, the fabric flange or mounting portion that is embedded inside the injection molded part serves at least two purposes, first it is embedded inside the part and forms a mechanical bond to both sides of the new part the new part by being molded and then by sewing it to the peripheral portion of an opening in the airbag or inflatable cushion it provides a gas tight seal around the airbag cushion opening. In an alternative exemplary embodiment, an adhesive may be used to secure the fabric mounting flange to the inflatable cushion. Accordingly, exemplary embodiments of the present invention provide a gas tight seal when the inflator is installed at assembly and during deployment.

Accordingly, exemplary embodiments of the present invention provide an easy and common universal attachment method to secure an airbag in an airbag module assembly.

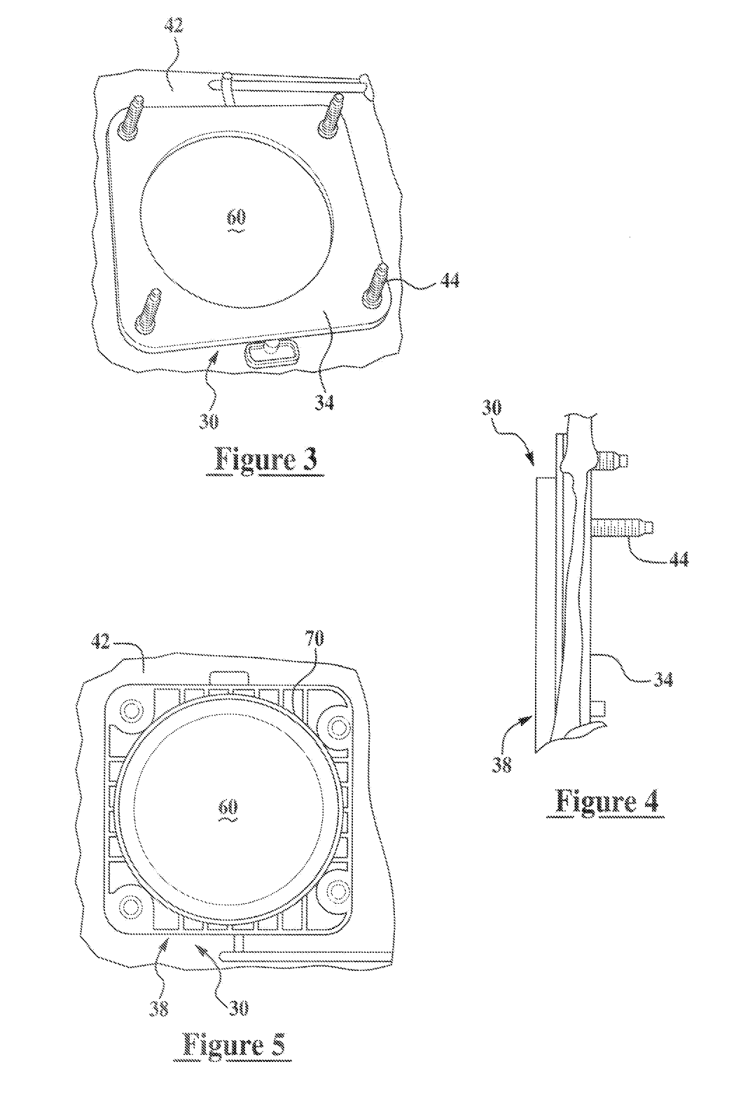

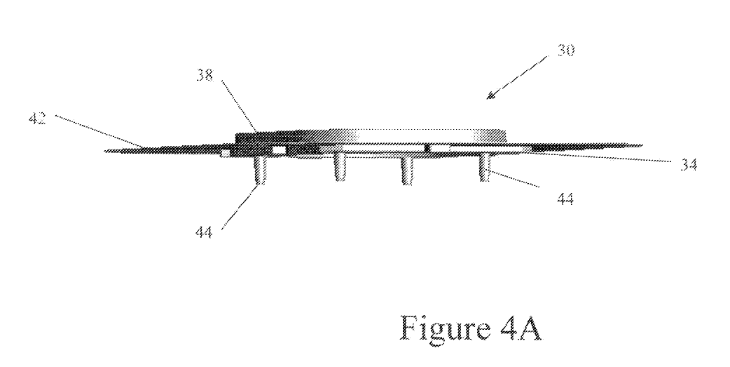

Referring now to FIGS. 3-7 and in accordance with an exemplary embodiment of the present invention, an integrally molded attachment device 30 is illustrated. In accordance with an exemplary embodiment, integrally molded attachment device 30 combines the features of cushion ring 24 and cover retainer 18 into a single item. The integrally molded attachment device also comprises a flexible portion or fabric mounting portion or flange 32 that has a plastic cover attachment plate 34 integrally molded to a first surface 36 of the flexible portion and a plastic cushion ring 38 integrally molded to a second surface 40 of the flexible portion.

In accordance with an exemplary embodiment, integrally molded attachment device 30 comprises a mounting portion 42 defined by a portion of the flexible portion that depends outwardly from an outer periphery of cushion ring 38 and attachment plate 34.

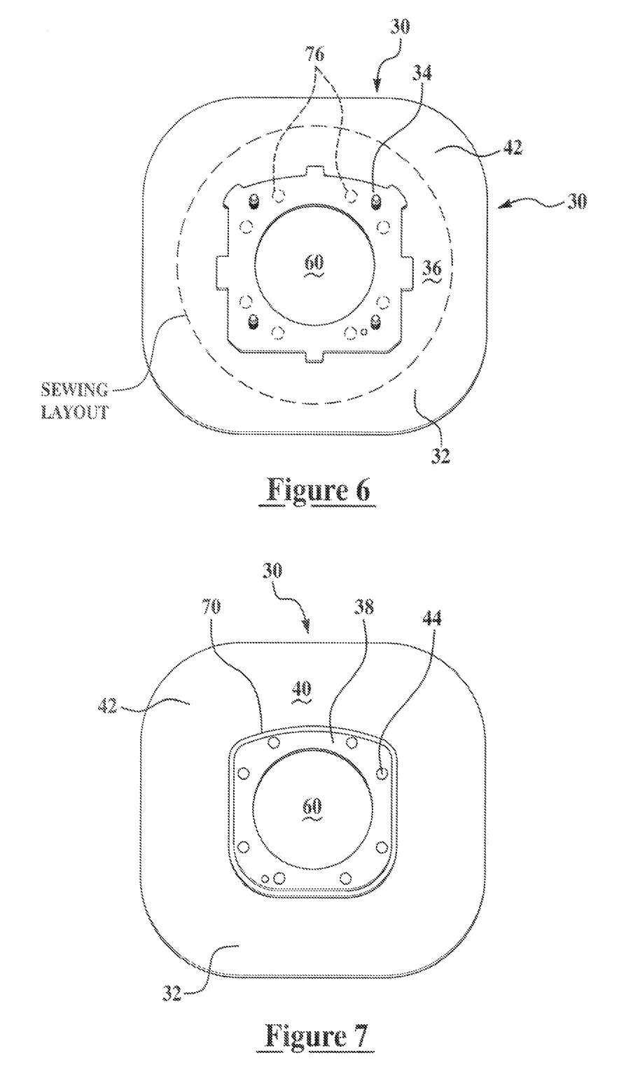

Mounting portion 42 provides a mounting surface, which in an exemplary embodiment is secured about an opening of an inflatable cushion by for example, stitching the same to or about a peripheral opening of the inflatable cushion. As illustrated, in FIG. 6 a sewing layout is provided for securing the mounting portion to an area adjacent to an opening of the inflatable cushion.

In accordance with one non-limiting exemplary embodiment, the flexible portion is manufactured out of the same material that is used for the inflatable cushion so that it will also be able to withstand the same deployment stresses as the inflatable cushion during a deployment as well as providing a flexible mounting surface that is integrally molded with cushion ring 38 and plate 34. A non-limiting example of this material is any suitable air bag material for holding gas. In an exemplary embodiment, the inflatable cushion comprises two sheets of woven nylon fabric lined with urethane or other substantially impervious material such as silicone. The two urethane coated nylon sheets in one embodiment are secured to one another along an outer periphery thereof to define the overall air bag shape. Accordingly, the flexible portion or fabric mounting flange is manufactured out of the same material as the inflatable cushion and is secured thereto by stitching and in one alternative embodiment the flexible portion or fabric mounting flange is secured thereto by stitching and adhesives such as silicone or equivalents thereof.

In accordance with an exemplary embodiment, integrally molded attachment device 30 is formed by an injection molding process, wherein flexible portion 32 is inserted within a pair of dies and cover plate 34 and cushion ring 38 are integrally molded about the flexible portion. In an exemplary embodiment, a plurality of plastic mounting studs 44 are insert molded into the integrally molded attachment device. Alternatively, non-plastic or metal studs are inset molded into the attachment device.

Thus, studs 44 will provide the means for securing attachment device 30 and the inflatable cushion to the inflator and the retainer plate via a plurality of nuts, and wherein pad retainer plate comprises a plurality of locking mechanisms for securing the plate and the assembled module to a portion of the vehicle such as a steering wheel armature. In addition and when employed in a driver's side airbag module, the pad retainer plate will provide a feature or features for securing an airbag module thereto for example, a plurality of peripheral tabs are provided on the pad retainer plate. Non-limiting examples of pad retainer plate 22 are found in the following U.S. Pat. Nos. 5,380,037; 6,092,832; 6,196,573; 6,237,944; and U.S. patent application Ser. Nos. 10/373,161, filed Feb. 24, 2003; 10/797,440 filed Mar. 10, 2004; 11/085,817 filed Mar. 21, 2005; and 11/184,059 filed Jul. 18, 2005, the contents each of which are incorporated herein by reference thereto.

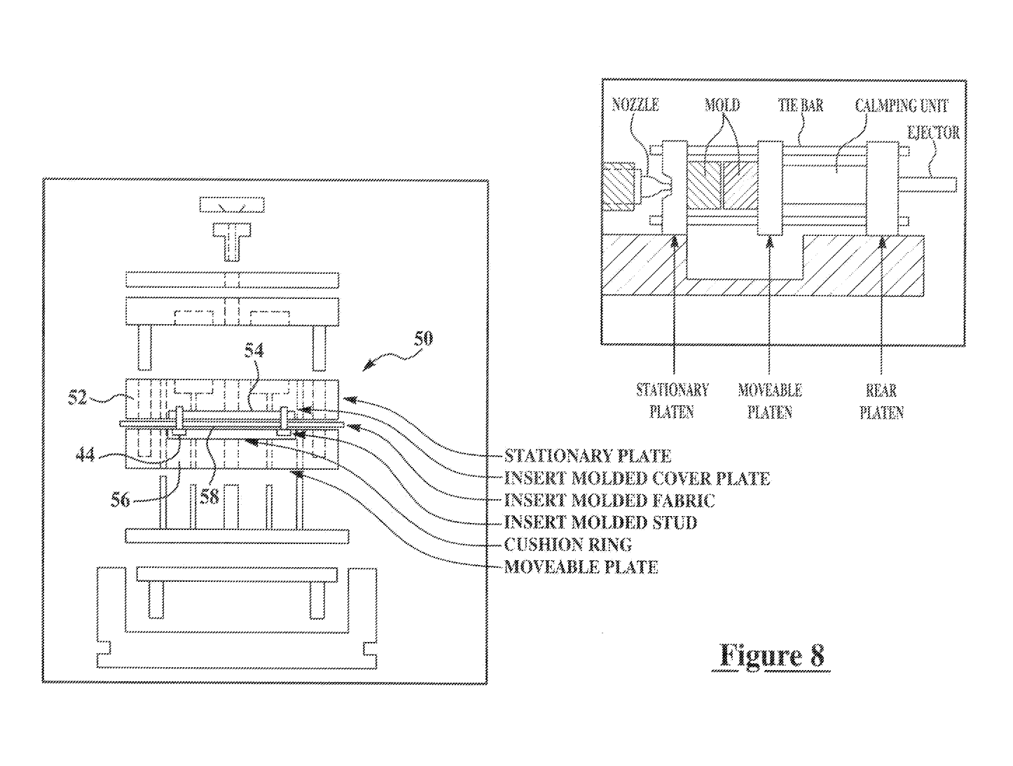

Referring now to FIG. 8, a non-limiting example of an injection molding apparatus 50 for injection molding the integrally molded attachment device 30 is illustrated. Injection molding device 50 comprises a first die 52 defining a first cavity portion 54 disposed in a facing spaced relationship with the first side of the flexible portion, and a second die 56 having a second cavity portion 58 disposed in a facing spaced relationship with the second side of the flexible portion.

In accordance with an exemplary embodiment, liquid plastic is injection molded into the first cavity portion and the second cavity portion, through at least one injection molding conduit wherein the cushion ring is formed on the first side of the flexible portion, and the cover retainer is formed on the second side of the flexible portion. In addition, and during the molding process, a portion of the flexible portion is mechanically bonded between the cushion ring and the cover retainer. In accordance with an exemplary embodiment, the cushion fabric comprising the flexible portion is formed of a material that will not melt during the injection molding process. Alternatively, the liquid plastic is insert molded at a temperature that does not result in the melting of the fabric portion.

Referring now to FIGS. 3-8, the cushion ring and the cover retainer each define an inflator opening 60 disposed within an outer periphery of the cover retainer and the cushion ring. Furthermore, and after the forming of the integrally molded attachment device, an inflator opening is also made in the flexible portion by removing (e.g., cutting) the portion disposed in the inflation opening defined by the cushion ring and the cover retainer.

In accordance with an exemplary embodiment, cushion ring 38 is configured to have a peripheral wall portion 70 that depends away from a surface of the fabric portion thus, providing some of the features of retainer ring 16.

In addition, and prior to the insertion of the molten plastic into the dies, the plurality of mounting studs are passed through openings in the fabric portion and are disposed into the first cavity portion and the second cavity portion, wherein the plurality of mounting studs are insert molded into the fabric portion, the cushion ring and the cover retainer. In other words, the liquid plastic of the cover retainer and the cushion ring will mold around the mounting studs inserted into the molding dies. In order to provide the threaded portion of the mounting studs, the same are disposed in cavities within the dies such that only a head portion and an upper portion of a shaft of the stud is integrally molded to the apparatus.

Exemplary embodiments provide a low cost method for attaching the inflatable cushion and airbag cover in an airbag module assembly. One advantage of exemplary embodiments of the present invention allows the functionality of the inflatable cushion retainer and the cover plate to be combined into a single injected molded part that has a piece of fabric or flexible member integrally molded directly thereto and a peripheral portion of the fabric will be used to attach the molded part to the inflatable cushion.

In accordance with an exemplary embodiment, a portion of the piece of fabric or flexible member comprising the mounting portion will extend outwardly from the molded area of the injection molding assembly. The portion of the fabric or flexible member extending out of the mold or dies of the assembly is also used to secure the apparatus to the inflatable cushion. In addition, and prior to the insertion of the liquid plastic as well as the closing of the dies, the piece of fabric or flexible member is pulled taught and held in that position until the injection molding process is complete.

In accordance with an alternative exemplary embodiment, a portion of the fabric portion is secured to the injection molded retainer ring and cover plate by means of a mechanical bonding wherein the fabric portion or flexible portion is configured to have a plurality of holes 76 located between the inner periphery of the inflator opening and the outer periphery of the retainer ring and the cover plate such that during the injection molding process the melted plastic is allowed to mix together through the holes or openings in the flexible portion from both sides of the dies used in the injection molding process.

In summary, this invention provides a lightweight, inexpensive, yet strong, one-piece construction airbag cushion attachment method that has incorporated into it a means to also attach and secure the airbag modules cover.

The flexible portion or fabric portion that is embedded inside the injection molded part is embedded inside the injection molded parts and forms a mechanical bond to both sides of the new part being formed by the injection molding process wherein the mounting portion of the flexible portion provides a gas tight seal around the airbag cushion opening after the same is sewed to the opening of the inflatable cushion along with a sealant material disposed therebetween. In other words, the injection molding process provides a gas tight seal as compared to the non-gas tight seal provided between the metal retainer ring and cover plate secured together by a plurality of separate bolts.

Although, a driver side airbag module is illustrated, alternative exemplary embodiments of the present invention are contemplated, other non-limiting uses include mounting mechanisms for side airbag modules, roof rail airbags and passenger airbags. For example, and referring to a passenger side airbag module the concept is the same the retainer ring and backing plate (if applicable) are replaced by an injection molded component having an integrally molded fabric flange for securement to the inflatable cushion. Again, the component may be directly molded to the fabric of the inflatable cushion. In yet another alternative and if no backing plate is required the mounting mechanism may be injection molded only with a retainer ring component on one side of the fabric layer with the mounting bolts extending therethrough.

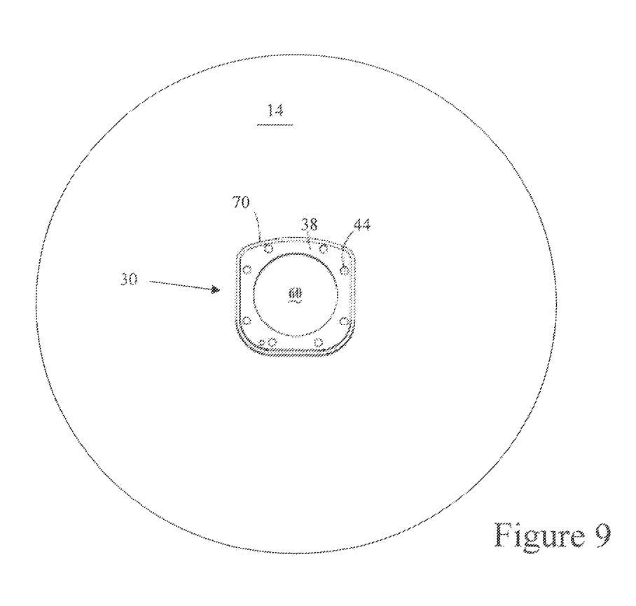

In yet another alternative exemplary embodiment and referring to FIG. 9, the portion of the fabric portion that is secured to the injection molded retainer ring is a portion of an inflatable cushion 14 thus, the injection molded retainer ring is directly secured to the fabric layer comprising a portion of the inflatable cushion. In one exemplary embodiment, the portion integrally molded to the retainer ring is a rear side of an inflatable cushion comprising at least two pieces of fabric (e.g., a rear side sewn or secured at its periphery to a front side or portion of the inflatable cushion). Alternatively, the inflatable cushion comprises a single layer of fabric integrally molded to the retainer ring. Accordingly and in this embodiment, the injection molded retainer ring is directly secured to the inflatable cushion.

Exemplary embodiments of the present invention improves the assembly of airbag modules by eliminating several processing steps typically encountered in the assembly of airbag modules. One non-limiting example is that the cushion attachment device improves the airbag cushion assembly process in the areas of cutting and sewing of cushion ring mounting holes and the sewing of a heat shield layers and reinforcing tethers around the airbag cushion opening by eliminating the aforementioned steps. The elimination of these process steps is accomplished by replacing it with the in-molded fabric piece (universal adapter, mounting portion or flexible portion) that will be sewed directly over the opening in the airbag cushion.

Another improvement is that the airbag cushion assembly process is simplified as the process steps of inserting the cushion ring into the airbag cushion and mounting the cover retainer over the cushion ring studs and bending over the locking tabs to secure the separate metal parts together to form the cushion assembly is eliminated. The elimination of this process step would be accomplished by sewing the injection molded part directly over the opening in the airbag cushion.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. An integrally molded attachment device for an inflatable cushion, comprising:
a flexible portion;
a cushion ring disposed on a first side of the flexible portion; and
a cover retainer disposed on a second side of the flexible portion, wherein the cushion ring and the cover retainer are formed by an injection molding process and wherein the flexible portion is disposed between the cushion ring and the cover retainer during the injection molding process.

2. The integrally molded attachment device as in claim 1, wherein the cushion ring and the cover retainer each define an inflator opening disposed within an outer periphery of the cover retainer and the cushion ring.

3. The integrally molded attachment device as in claim 2, wherein the flexible portion is a piece of fabric and the fabric has a mounting portion extending outwardly from the outer periphery of the cover retainer and the cushion ring.

4. The integrally molded attachment device as in claim 3, wherein the mounting portion extends away from the entire periphery of the outer periphery of the cover retainer and the cushion ring.

5. The integrally molded attachment device as in claim 1, wherein the flexible portion is an integral portion of an inflatable cushion.

6. The integrally molded attachment device as in claim 1, further comprising a plurality of mounting studs insert molded into the flexible portion, the cushion ring and the cover retainer.

7. The integrally molded attachment device as in claim 1, wherein the flexible portion is mechanically bonded to the cover retainer and the cushion ring as the cover retainer and the cushion ring are formed by the injection molding process, wherein the flexible portion has a plurality of holes disposed between the cover retainer and the cushion ring and a portion of the material comprising the cushion ring and the cover retainer passes through the plurality of holes and the portion is integrally formed with the cushion ring and the cover retainer during the injection molding process.

8. The integrally molded attachment device as in claim 1, wherein the cushion ring further comprises a peripheral wall depending away from the first side of the cushion member.

9. The integrally molded attachment device as in claim 1, wherein the cushion ring and the cover retainer are plastic.

10. The integrally molded attachment device as in claim 1, wherein the cushion ring and the cover retainer are plastic and the flexible portion comprises a material, that will not melt during the injection molding process.

11. An airbag module, comprising:
an inflator for providing an inflation force to an inflatable cushion;
a flexible portion;
a cushion ring disposed on a first side of the flexible portion; and
a cover retainer disposed on a second side of the flexible portion, wherein the cushion ring and the cover retainer are formed by an injection molding process and wherein the flexible portion is disposed between the cushion ring and the cover retainer during the injection molding process.

12. The airbag module as in claim 11, wherein the cushion ring, flexible portion and the cover retainer each define an inflator opening disposed within an outer periphery of the cover retainer, flexible portion and the cushion ring, wherein the inflator opening of the cover retainer, flexible portion and the cushion ring is configured to receive a portion of the inflator therein and the outer periphery of the flexible portion is larger than the outer periphery of the cover retainer and the cushion ring.

13. The airbag module as in claim 11, wherein the flexible portion has a mounting portion located between the outer periphery of the flexible portion and the outer periphery of the cover retainer and the cushion ring.

14. The airbag module as in claim 13, wherein the mounting portion is secured to an opening of the inflatable cushion and the flexible portion is formed from the same material of the inflatable cushion.

15. The airbag module as in claim 11, further comprising a plurality of mounting studs insert molded into the flexible portion, the cushion ring and the cover retainer, the plurality of mounting studs being configured to secure the inflator into the inflator opening.

16. The airbag module as in claim 11, wherein the flexible portion is formed from the same material of the inflatable cushion and the inflatable cushion is mechanically bonded to the cover retainer and the cushion ring as the cover retainer and the cushion ring are formed by the injection molding process, wherein the flexible portion has a plurality of holes disposed between the cover retainer and the cushion ring and wherein the flexible portion has a mounting portion located between the outer periphery of the flexible portion and the outer periphery of the cover retainer and the cushion ring, wherein the mounting portion is sewn proximate to an opening of the inflatable cushion and the flexible portion is formed from the same material of the inflatable cushion.

17. The airbag module as in claim 11, wherein the cushion ring further comprises a peripheral wall depending away from the first side of the flexible portion.

18. The airbag module as in claim 11, wherein the cushion ring and the cover retainer are plastic and the flexible portion comprises a material, that will not melt during the injection molding process and wherein the flexible portion is an integral portion of the inflatable cushion.

19. A method for integrally molding an attachment device for an inflatable cushion, comprising:
inserting a flexible portion within a pair of dies, a first one of the pair of dies having a first cavity portion disposed in a facing spaced relationship with a first side of the flexible portion, and a second one of the pair of dies having a second cavity portion disposed in a facing spaced relationship with a second side of the flexible portion; and
molding a liquid plastic into the first cavity portion and the second cavity portion, wherein a cushion ring is formed on the first side of the flexible portion, and a cover retainer is formed on the second side of the flexible portion, and a portion of the flexible portion is mechanically bonded between the cushion ring and the cover retainer.

20. The method as in claim 19, wherein the cushion ring and the cover retainer each define an inflator opening disposed within an outer periphery of the cover retainer and the cushion ring.

21. The method as in claim 19, wherein a portion of the flexible portion is not disposed in the first cavity portion and the second cavity portion of the pair of dies, the portion comprising a mounting portion extending outwardly from the outer periphery of the cover retainer and the cushion ring.

22. The method as in claim 19, further comprising:
inserting a plurality of mounting studs into the first cavity portion and the second cavity portion, wherein the plurality of mounting studs are insert molded into the flexible portion, the cushion ring and the cover retainer.

23. The method as in claim 19, wherein the flexible portion comprises a material that will not melt during the molding process.

24. An attachment device formed by the process of claim 19.

25. The method as in claim 19, wherein the flexible portion is an integral portion of the inflatable cushion.
